(19) United States
(12) Patent Application Publication
(10) Pub. No.: US 2015/0113174 A1
(43) Pub. Date: Apr. 23, 2015

(54) INTELLIGENT SUPERVISION FOR CONFIGURATION OF PRECISION TIME PROTOCOL (PTP) ENTITIES

(71) Applicants: Qingfeng Yang, Montreal (CA); Baifeng Cui, Beijing (CN)

(72) Inventors: Qingfeng Yang, Montreal (CA); Baifeng Cui, Beijing (CN)

(73) Assignee: TELEFONAKTIEBOLAGET L M ERICSSON (PUBL), Stockholm (SE)

(21) Appl. No.: 14/398,576

(22) PCT Filed: May 3, 2012
(86) PCT No.: PCT/CN2012/075019

§ 371 Date: Nov. 3, 2014

(51) Int. Cl. H04L 29/08

(52) U.S. Cl. CPC H04L 67/1095
USPC 709/248

(57) ABSTRACT

An intelligent supervisor located at a management node in the PTP network determines the PTP roles and configuration of the client nodes. The intelligent supervisor communicates with intelligent supervisor agents located at client nodes in the PTP network. The intelligent supervisor agents at the client nodes feed back information, such as the PTP properties of the client nodes, to the intelligent supervisor. The intelligent supervisor analyzes the data to determine the roles and appropriate configuration for the client nodes.

### TECHNICAL FILED

The present invention relates generally to synchronization of nodes in a communication network and, more particularly, to the configuration of precision time protocol (PTP) entities in a communication network.

### BACKGROUND

The IEEE 1588 standard is known as “Precision Clock Synchronization Protocol for Networked Measurement and Control Systems” or “PTP” for short. PTP was originally standardized by the IEEE in 2002. In 2008 a revised standard, IEEE 1588-2008 was released. This new version, also known as PTP Version 2, improves accuracy, precision and robustness, but is not backwards compatible with the original 2002 version.

PTP is a protocol used to synchronize clocks throughout a network. It defines a procedure allowing many spatially distributed real-time clocks to be synchronized through a “package-compatible” network (normally Ethernet). On a local area network, it achieves clock accuracy in the sub-microsecond range, making it suitable for measurement and control systems. The challenge is to synchronize networked devices with each other in terms of time with a precise system time stamp. Based on this time stamp, the measured time difference values can then be correlated with each other.

In Ethernet systems, unpredictable collisions due to the CSMA/CD procedure may lead to time packages being delayed or disappearing completely. For this reason, IEEE 1588 defines a special “clock synchronization” procedure. First, one node (the IEEE 1588 master clock) transmits a “Sync” packet, which contains the estimated transmission time. The exact transmission time is captured by a clock and transmitted in a second “Follow Up” message. Based on the first and second packet and by means of its own clock, the receiver can now calculate the time difference between its clock and the master clock. To achieve the best possible results, the PTP time stamps should be generated in hardware or as close as possible to the hardware. The packet propagation time is determined cyclically in a second transmission process between the slave and the master (“delay” packet). The slave can then correct its clock and adapt it to the current bus propagation time.

PTP service is widely used in Ethernet networks as a mechanism for time and/or frequency synchronization. Currently, the network operators configure the PTP services manually. For large networks with many nodes, the configuration of PTP services can be complex. The network operator must determine the appropriate role and PTP settings for each node. The role determination for nodes should take into account many factors, such as the network topology, the node's location in the network, the node's capabilities, and the number of customers served by the node. Role determination is also complicated by the dependencies among the nodes. Exemplary settings for a node include the time property, local clock, parent clock, PTP port, announce interval/timeout, delay mechanism, and delay request interval. This list is not exhaustive but illustrates the complexity involved in configuring PTP settings for many nodes.

Another drawback with manual configuration is that the network configuration may change over time as nodes are added to or removed from the network. Additionally, the number of customers served by a given node may change over time. Thus, the configuration of PTP services needs to be reevaluated periodically and appropriate changes need to be made as the network configuration changes. The reconfiguration of the PTP service when the network configuration changes can be time consuming and costly for the network operator.

From the standpoint of the network operator, network management systems should be user friendly, easy to use, and provide flexibility as the network configuration changes to allow the network operator to optimize the network performance and maximize revenues. Currently, there is a need for a network management system to help network operators configure and deploy PTP networks.

### SUMMARY

The present invention provides a network management system to simplify the configuration and deployment of PTP networks. A logical entity referred to as the intelligent supervisor is located at a management node in the PTP network. The intelligent supervisor communicates with intelligent supervisor agents located at client nodes in the PTP network. The intelligent supervisor agents at the client nodes feed back information, such as the PTP properties of the client nodes, to the intelligent supervisor. The management node analyzes the PTP properties of the client nodes, along with information about the network topology and other relevant information, to determine the PTP roles and configuration for the client nodes.

Exemplary embodiments of the invention comprise methods implemented at a management node in a communication network of configuring precision time protocol (PTP) entities at one or more client nodes in the communication network. In one exemplary method, the management node determines PTP properties of PTP entities at one or more of the client nodes, and collects network topology information for the communication network. The management node then defines PTP roles for one or more target PTP entities based on the PTP properties of the client nodes and the network topology information. PTP configurations for the target PTP entities is then determined based on their respective PTP roles. The PTP configurations are sent to respective ones of the client nodes for configuring the target PTP entities.

Other embodiments of the invention comprise a management node in a communication network. The management node comprises a network interface for communicating with one or more client nodes in the communication network and a processing circuit connected to the network interface for configuring precision time protocol (PTP) entities in the communication network at one or more of the client nodes. The processing circuit determines PTP properties of PTP entities at one or more of the client nodes and collects network topology information for the communication network. Based on the PTP properties and network topology information, the processing circuit defines PTP roles for one or more target PTP entities, determines PTP configurations for the target PTP entities, and sends the PTP configurations to respective ones of the client nodes for configuring the target PTP entities.

Other embodiments of the invention comprise methods implemented at a client node in a communication network of configuring precision time protocol (PTP) entities the client node. In one exemplary method, the client node sends PTP properties of the PTP entity to a management node. Subsequently, the client node receives a PTP configuration for the PTP entity at the client node from the management node. The client node executes a configuration procedure to configure the PTP entity according to the PTP configuration received from the management node.

Other embodiments of the invention comprise a client node in a communication network. In one embodiment, the client node comprises a network interface for communicating with a management node in the communication network, and a processing circuit connected to the network interface for configuring a precision time protocol (PTP) entity in the client node. The processing circuit is configured to send PTP properties of the PTP entity to a management node, and to receive in response a PTP configuration from the management node. The processing circuit then executes a configuring procedure to configure the PTP entity according to the PTP configuration received from the management node.

The exemplary embodiments described simplify the deployment and configuration of PTP networks. The configuration procedures can be fully automated to optimize the synchronization performance. Further, the network can be reconfigured automatically responsive changes in the network, e.g., when a new node is deployed or a node is removed.

### BRIEF DESCRIPTION OF THE DRAWINGS

FIG. 1 illustrates a communication network according to one embodiment including an intelligent supervisor for configuring PTP entities at the network nodes.

FIG. 2 illustrates the main functional elements of a network node including an intelligent supervisor.

FIG. 3 illustrates the main functional elements of a network node including an intelligent supervisor agent.

FIG. 4 illustrates an exemplary setup procedure for configuring a PTP entity at a network node.

FIG. 5 illustrates an exemplary recovery procedure for reconfiguring one or more PTP entities responsive to detection of a fault.

FIG. 6 illustrates an exemplary method implemented by an intelligent supervisor for determining the configuration of one or more PTP entities.

FIG. 7 illustrates an exemplary method implemented by an intelligent supervisor agent configuring a PTP entity at a network node.

### DETAILED DESCRIPTION

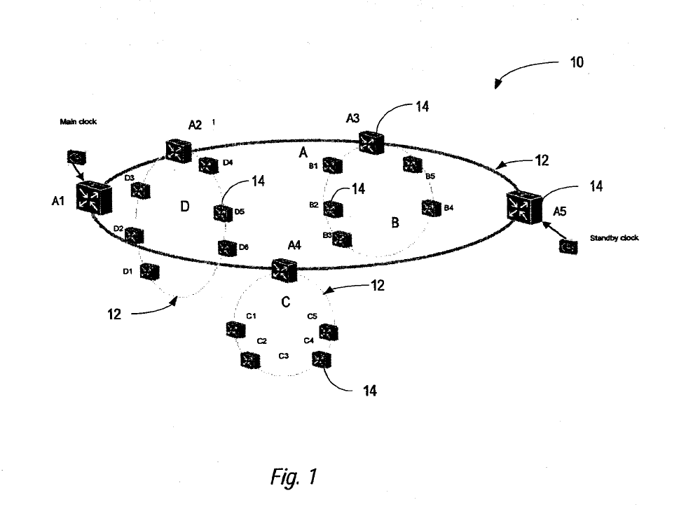

Referring now to the drawings, FIG. 1 illustrates an exemplary communication network 10 implementing the Precision Time Protocol (PTP). The exemplary communication network 10 shown in FIG. 1 uses a ring topology. Those skilled in the art will appreciate that the present invention is not limited to use in networks with a ring topology, but could also be used in communication networks 10 with bus, tree, star, or mesh topologies, or a combination of different topologies. The communication network 10 of FIG. 1 includes four rings 12 denoted by the letters A, B, C, and D. Each ring 12 includes a plurality of nodes 14.

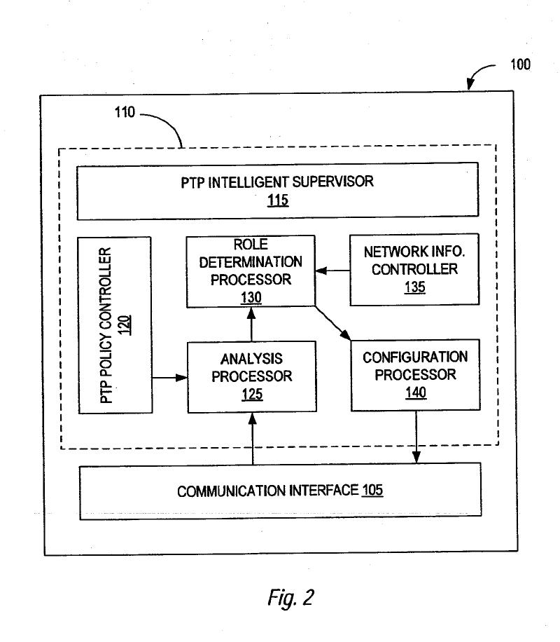

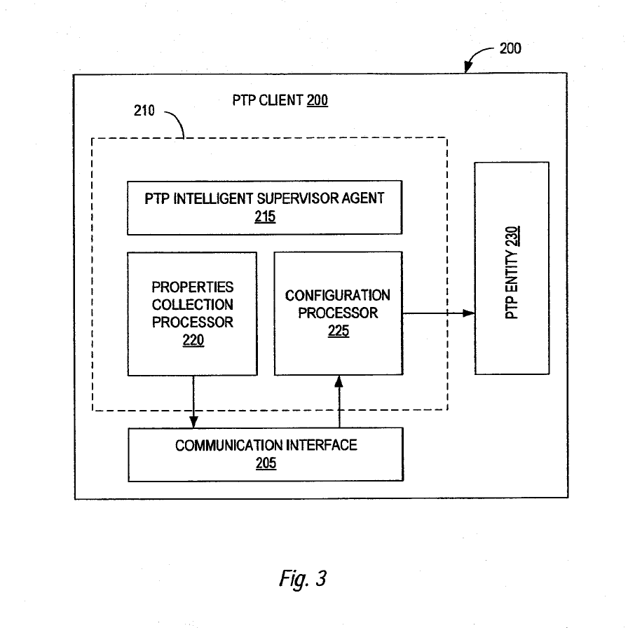

The main ring A includes five nodes 14 denoted as nodes A1-A5 respectively. Nodes A1 and A5 are configured to serve as PTP grandmaster or management (GM/M) nodes 100 for the network 10. Node A1 serves as the primary GM/M node 100 (FIG. 2), while node A5 serves as the backup GM/M node 100. Nodes A2-A4 serve as switching nodes connecting the rings B-D with the main ring A. Nodes A2-A4 are configured as PTP client nodes 200 (FIG. 3) operating in boundary clock (BC) mode. Nodes B1-B5 are device nodes on ring B, C1-C5 are device nodes on ring C, and nodes D1-D6 are device nodes on ring D. These device nodes are also configured as PTP client nodes 200 operating in ordinary clock (OC) mode. FIG. 2 illustrates components of a GM/M node 110 in one exemplary embodiment.

The GM/M node 100 comprises a communication interface 105, and a PTP processing circuit 110. The communication interface 105 provides connection to the communication network 10 using known communication protocols, such as the Ethernet protocol. The main functions of the PTP processing circuit 110 are to collect information about the network topology and the PTP properties of the client nodes 200, to determine the appropriate roles for the client nodes 200, to select the appropriate PTP configuration for the client nodes 200, and to send the selected PTP configurations to the client nodes 200.

The main functional components of the PTP processing circuit 110 include the intelligent supervisor (IS) 115, the PTP policy controller 120, the analysis processor 125, the role determination processor 130, the network information controller 135, and the configuration processor 140. These components may be implemented by one or more microprocessors, hardware, or a combination thereof.

The intelligent supervisor 115 comprises the main control logic for the GM/M node 100. It communicates with the client nodes 200 to collect information about the PTP properties. It may also communicate with other nodes within the communication network to collect information about the network topology. It also controls and coordinates the operations of the other components in the processing circuit 110 to perform self-configuration of the PTP network and to optimize PTP network deployment.

The PTP policy controller 120 provides rules and requirements for the different PTP roles. For example, a client node may serve as a boundary clock (BC), ordinary clock (OC) master or slave, or transparent clock (TC). The rules may be configured in advance by the network operator or generated at decision time. The rules may, for example, provide time source and clock accuracy restrictions for boundary clocks and master clocks, required number of ports for boundary clocks and transparent clocks, and the maximum number of slave clocks below a boundary clock or master clock.

The analysis processor 125 determines the candidate roles for the client nodes 200 based on the PTP properties of the client nodes 200 and the rules provided by the PTP policy controller 120. In general, the analysis processor 125 compares the PTP properties for the client nodes 200 with the requirements for each role provided by the PTP policy controller 120 to determine the roles for which the client node 200 is eligible. The analysis processor 125 then generates a candidate list including the roles for which the client node 200 is eligible and provides the candidate list to the role determination processor 130.

The role determination processor 130 determines the roles for the client nodes 200 based on the candidate list provided by the analysis processor 125, information about the network topology, and information about the existing PTP network. Generally, the role determination processor 130 determines the network identity and location of the client node 200 in the network from the network topology information. The role determination processor 130 then selects an appropriate PTP role from the candidate list based on the location of the client node in the network 10. The role determination along with the network identity of the client node 200 is then sent to the configuration processor 140.

The configuration processor 140 includes a configuration database that stores a PTP configuration for each of the candidate roles. The PTP configuration comprises the collection of settings for one or more PTP configuration parameters. Based on the role determination provided by the role determination processor 130, the configuration processor 140 selects the corresponding PTP configuration form the configuration database and sends the selected PTP configuration to the client node 200.

FIG. 3 illustrates components of a client node 200 in one exemplary embodiment. The client node 200 comprises a network interface adapter 205, and a PTP processing circuit 210. The network interface adapter 205 provides connection to the communication network 10 using known communication protocols, such as the Ethernet protocol. The main functions of the PTP processing circuit 210 are to collect the PTP properties of the client nodes 200, send the PTP properties to the GM/M node 100, receive a PTP configuration from the GM/M node 100, and configure a PTP entity at the client node 200.

The main logical components of the PTP processing circuit 210 include the intelligent supervisor agent (IS) 215, the properties collection processor 220, and the configuration processor 225. These components may be implemented by one or more microprocessors, hardware, or a combination thereof. The intelligent supervisor agent 215 comprises the main control logic for the client node 200. It communicates with the GM/M node 100 to send the PTP properties of the client node 200, and to receive a PTP configuration from the GM/M node 100. It also controls and coordinates the operations of the other components in the processing circuit 210.

The properties collection processor 220 collects PTP-specific information about the client node 100, which is fed back to the GM/M node 100. The PTP-specific information includes one or more of the following properties, which are defined in IEE 1588 v. 2:
timePropertiesDS.timeSource
defaultDS.clockQuality.ClockAccuracy(already include holdover specification of the clock)
defaultDS.clockQuality.offsetScaledLogVariance
defaultDS.numberPorts
PTP message transport mechanism
   This listing is exemplary of the types of information useful for PTP configuration and could include other properties relevant to PTP configuration.

The configuration processor 225 receives the PTP configuration from the GM/M node 100 and configures a PTP entity 230 according to the specified PTP configuration. The configuration processor 225 may configure the PTP entity during initial set-up of the PTP entity 230. The configuration processor 225 may also reconfigure an existing PTP entity 230 responsive to changes in the network configuration.

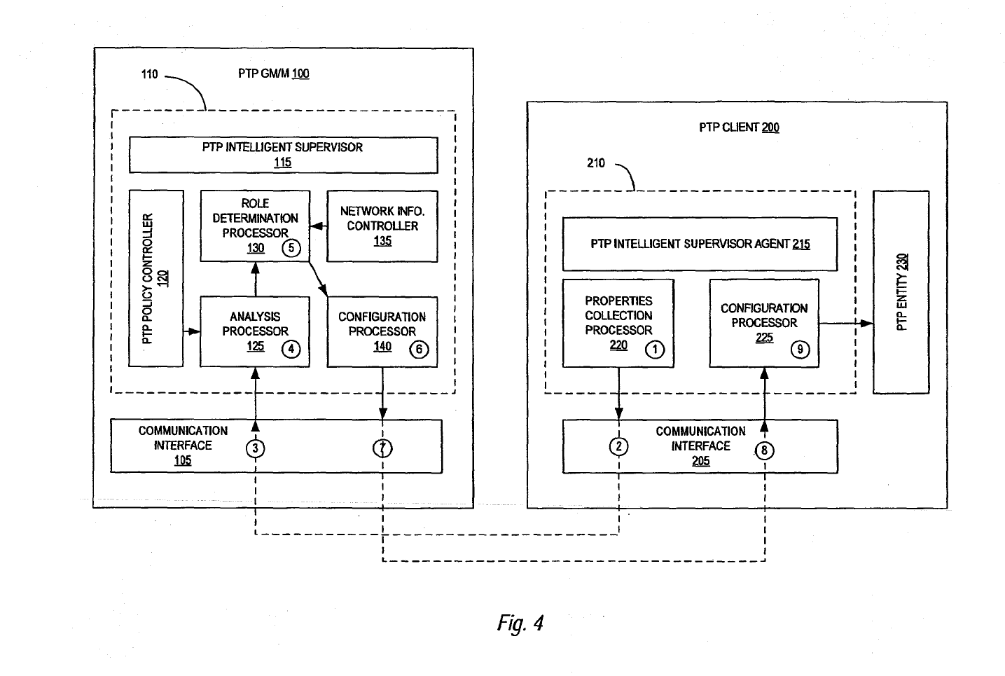

FIG. 4 illustrates a sequence of steps in one exemplary embodiment for configuring a new PTP entity 230 when a PTP client is initially set up. The intelligent supervisor agent 215 triggers the set-up procedure when the client node 200 is set-up. The properties collection processor 220 collects the basic PTP properties of the client node 200 (step 1). The communications interface 205 at the client node 200 assembles the PTP properties into a set-up request message and sends the PTP properties to the GM/M node 100 (step 2).

The set-up request message is received by the communications interface 105 at the GM/M node 100. The communications interface 105 extracts the PTP properties from the received request message and sends the PTP properties to the analysis processor 125 (step 3). The analysis processor 125 analyzes the PTP properties according to the rules and restrictions provided by the PTP policy controller 120 to determine a set of candidate roles for the client node 100 and provides a candidate list to the role determination processor 130 (step 4). The role determination processor 130 will then select an appropriate PTP role from the list of candidate roles based on the network topology and location of the client node (step 5). Information about the network topology and location of the client node is provided by the network information controller 135. The role determination processor 130 sends the network identity and selected PTP role to the configuration processor 140. The configuration processor 140 then selects the PTP configuration from a configuration database based on the PTP role determination (step 6). The configuration database may store predefined configurations for each possible role. In other embodiments, the configuration processor may dynamically generate the PTP configuration. The PTP configuration is sent to the communications interface 105, which assembles the PTP configuration into a response message and sends the response message with the PTP configuration to the client node 200 (step 7).

The response message is received by the communications interface 205 at the client node 200. The communications interface 205 extracts the PTP configuration information from the response message and sends the PTP configuration to the configuration processor 225 (step 8). The configuration processor 225 then configures a PTP entity 230 according to the instructions provided by the GM/M node 100 and starts the PTP entity (step 9).

Referring to FIG. 1, assume that a fault occurs removing node A2 from service. In this case, nodes D1-D6 will connect directly to node A1, which may cause congestion and/or overloading at A1. The overloading of the GM/M node 100 may degrade the service capacity of the GM/M node 100 and affect the synchronization performance of the whole PTP network. To avoid degradation in performance due to a fault, the present invention can be used to reconfigure one or more of the existing PTP nodes responsive to the detection of the fault so as to optimize PTP performance. In the scenario described above, another node on ring D should be selected to operate as the boundary clock to avoid congestion at the GM/M node 100. For example, node D3 could be selected to operate as a boundary clock. In this case, node D3 will communicate directly with the GM/M node 100. The remaining nodes on ring D will communicate with node D2.

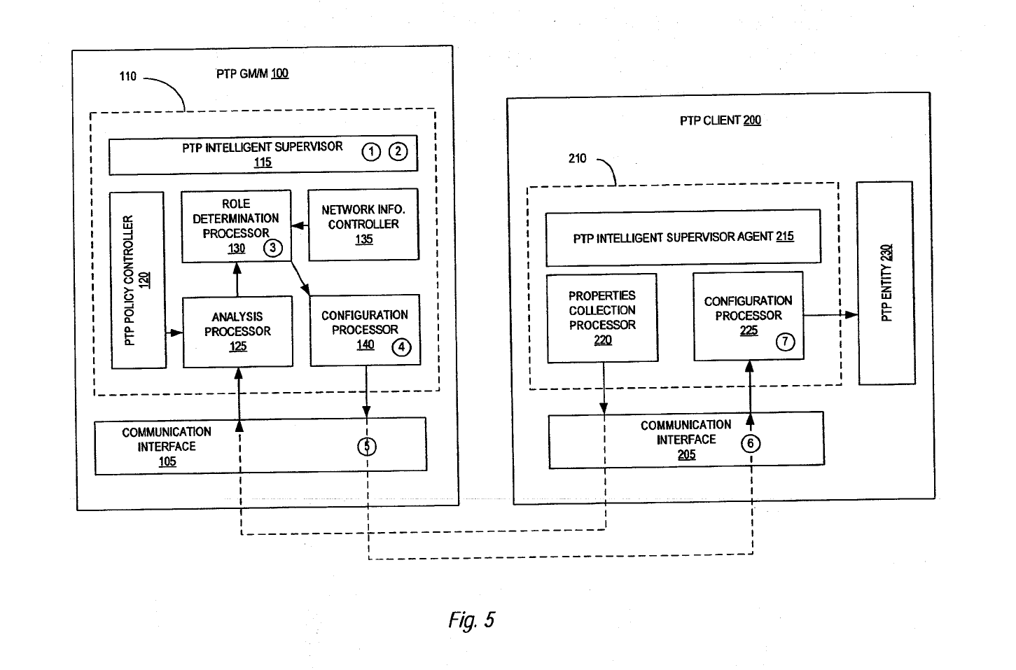

FIG. 5 illustrates a sequence of steps in one exemplary embodiment for reconfiguring a PTP entity 230 responsive to the detection of a fault in the network 10. The intelligent supervisor agent 215 at the faulty node sends a fault notification message to the GM/M node 100 responsive to the detection of the fault (step 1). Alternatively, the intelligent supervisor 115 at the GM/M node 100 could detect the fault, or receive a fault notification from another client node. The intelligent supervisor 115 then triggers the reconfiguration procedure by sending a command to the role determination processor 130 (step 2).

The role determination processor 130 determines the action that needs to be taken depending on the network topology, the location of the faulty node, and the current configuration of the PTP network. If the faulty node is operating as a TC, the role determination processor 130 updates the network topology. No other action is required. If the faulty node is operating as an OC slave, or as both an OC slave and TC, the role determination processor 130 updates the network topology and the number of OC slaves currently below the corresponding BC or OC master. However, if the faulty node is serving as a BC or OC master, the role determination processor 130 should select another client node 200 to serve as a BC or OC master. In this case, the procedure continues with the selection and promotion of client node 100 to serve as the new BC or OC master (step 3). The role determination processor sends the network identity of the promoted client node and the PTP role to the configuration processor 140. The configuration processor 140 then selects the PTP configuration from a configuration database based on the PTP role determination (step 4). The PTP configuration is sent to the communications interface 105, which assembles the PTP configuration into a reconfiguration message and sends the reconfiguration message with the PTP configuration to the promoted client node 200 (step 5).

The reconfiguration message is received by the communications interface 205 at the promoted client node 200. The communications interface 205 extracts the PTP configuration information from the reconfiguration message and sends the PTP configuration to the configuration processor 225 (step 6). The configuration processor 225 then reconfigures a PTP entity 230 according to the instructions provided by the GM/M node 100 and restarts the PTP entity in BC or OC master mode (step 7).

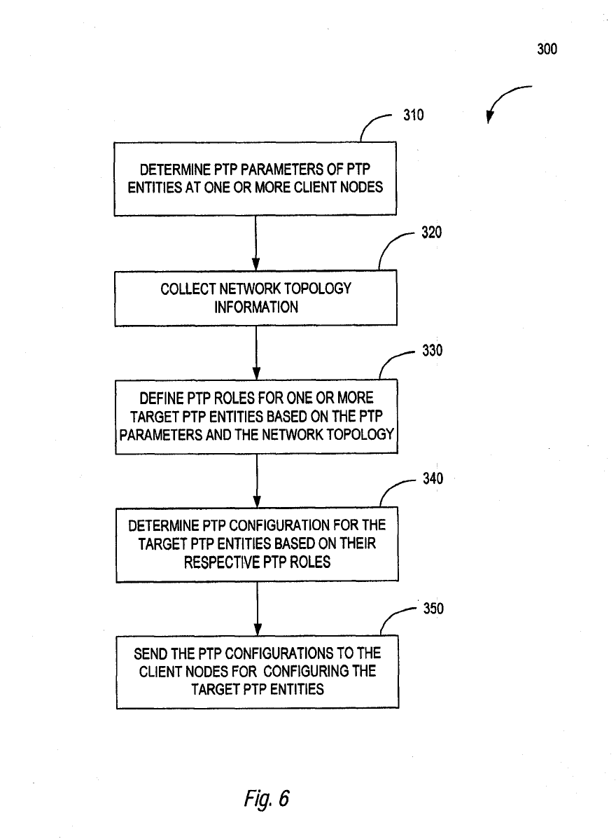

FIG. 6 illustrates an exemplary method 300 implemented by a management node 100 (e.g., GM/M node) in a communication network 10 for configuring precision time protocol entities at one or more client nodes 200 in the communication network. The management node 100 determines PTP properties of PTP entities at one or more client nodes (block 310). The management node 100 also collects the network topology information for the communication network (block 320). The management node 100 then defines PTP roles for one or more target PTP entities based on the PTP properties and the network topology (block 330). As previously described, the step of defining the PTP roles of the client nodes may be performed in two steps. In the first step, the candidate roles for the PTP entities may be determined based on the PTP properties and a defined set of rules. In the second step, the appropriate PTP role may be selected from the candidate roles based on the network topology and the location of the client node hosting the target PTP entity. After the PTP role is determined for a target PTP entity, the management node determines the PTP configuration for the target PTP entity based on the selected PTP role (block 340). The PTP configuration may be predefined and stored in a configuration database. In other embodiments, the PTP configuration may be dynamically generated. The management node 100 then sends the PTP configurations to the client nodes 200 where the target PTP entities are located (block 350).

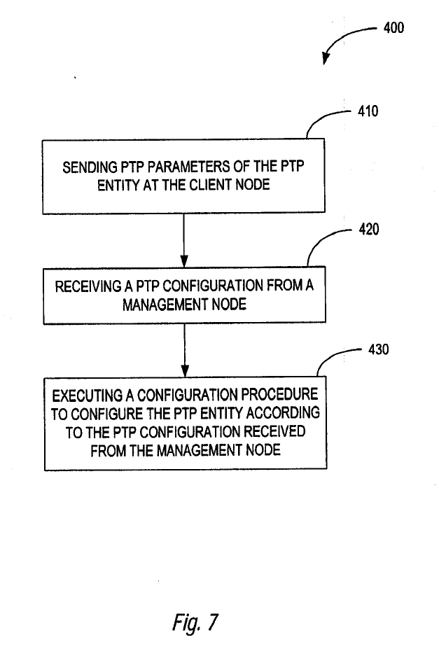

FIG. 7 illustrates a corresponding method 400 implemented by a client node 200 for configuring a PTP entity at the client node 200. The method begins with the client node 200 sending PTP properties of the PTP entity at the client node 200 to the management node. In some embodiments, the PTP properties could be reset in a request message during a setup procedure. In other embodiments, the client node 200 may send the PTP properties responsive to a request from the management node 100. After sending the PTP properties to the management node 100, the client node 200 receives a PTP configuration from the management node 100 (block 420). Responsive to receipt of the PTP configuration from the management node 100, the client node 200 executes a configuration procedure to configure the PTP entity according to the PTP configuration received from the management node 100 (block 430).

The present invention simplifies configuration of the PTP network, which reduces the cost of network maintenance. Standard or custom PTP configurations may be stored in the configuration database. When a new client node is added to the PTP network, the automated procedures can be executed to configure the PTP entity at the new client node 200. Similarly, when a fault is detected, the PTP entities at one or more client nodes can be reconfigured to optimize the synchronization performance of the PTP network. The automated procedures reduce the labor involved in configuring the PTP network and save the network operator cost.

The procedures as herein described use a centralized management node 100 to optimize the PTP network. The centralized management node 100 is able to analyze the network topology, location of various client nodes, and node capabilities to optimize the performance of the PTP network. PTP networks are sensitive to the path-packet delay variation and asymmetry from master to slave. The present invention enables a more balanced setup to achieve better optimization of the PTP network. The present invention also enables quicker recovery when synchronization is lost due to failure of a network node.

The present invention makes it easier to expand the network by adding new nodes. Further, the present invention enables automatic recovery when a network node fails.

What is claimed is:

1. A method implemented at a management node in a communication network of configuring precision time protocol (PTP) entities at one or more client nodes in the communication network, said method comprising:
determining PTP properties of PTP entities at one or more of the client nodes;
collecting network topology information for the communication network;
defining PTP roles for one or more target PTP entities based on the PTP properties of the client nodes and the network topology information;
determining PTP configurations for the target PTP entities based on their respective PTP roles; and
sending the PTP configurations to respective ones of the client nodes for configuring the target PTP entities.

2. The method of claim 1 wherein determining PTP properties of PTP entities at one or more of the client nodes includes receiving said PTP properties from said one or more client nodes.

3. The method of claim 1 wherein defining PTP roles for one or more target PTP entities comprises:
determining a set of candidate PTP roles for each of said PTP entities based on the PTP properties of the PTP entities and a set of PTP policies; and
selecting a PTP role for each of said PTP entities from its candidate set based on the network topology information.

4. The method of claim 1 wherein determining PTP configurations for the target PTP entities comprises selecting, for each PTP entity, a predefined PTP configuration from a configuration database based on the selected candidate PTP role.

5. The method of claim 4 further comprising storing the predefined PTP configurations in a configuration database at the management node.

6. The method of claim 1 wherein defining PTP roles for one or more target PTP entities based on the PTP properties of the client nodes and the network topology information is performed responsive to a setup request from a client node.

7. The method of claim 1 wherein defining PTP roles for one or more target PTP entities based on the PTP properties of the client nodes and the network topology information is performed responsive to a fault at a client node.

8. The method of claim 7 further comprising detecting, by said management node, a fault at one of said client nodes.

9. The method of claim 7 further comprising receiving, at said management node, a fault notification message from one or said client nodes.

10. A management node in communication network comprising:
a network interface for communicating with one or more client nodes in the communication network;
a processor connected to the network interface for configuring precision time protocol (PTP) entities in the communication network at one or more of the client nodes, said processor configured to:
determine PTP properties of PTP entities at one or more of the client nodes;
collect network topology information for the communication network;
defining PTP roles for one or more target PTP entities based on the PTP properties of the client nodes and the network topology information;
determine PTP configurations for the target PTP entities; and
send the PTP configurations to respective ones of the client nodes for configuring the target PTP entities.

11. The management node of claim 10 wherein the processor is configured to receive said PTP properties from said one or more client nodes via said network interface.

12. The management node of claim 10 wherein the processor comprises:
an analysis module for determining a set of candidate PTP roles for each of said PTP entities based on the PTP properties of the PTP entities and a set of PTP policies; and
a role determination module for selecting the PTP role for each of said PTP entities from its candidate set based on the network topology information.

13. The management node of claim 10 wherein the processor further includes a configuration module for determining PTP configurations for the target PTP entities, and wherein the configuration module is configured to select, for each PTP entity, a predefined PTP configuration from a configuration database based on the selected candidate PTP role.

14. The management node of claim 4 further comprising memory for storing a configuration database including the predefined PTP configurations.

15. The management node of claim 10 wherein the processor is configured to define PTP roles for one or more target PTP entities responsive to a setup request from a client node.

16. The management node of claim 10 wherein the processor is configured to define PTP roles for one or more target PTP entities responsive to a fault at a client node.

17. The management node of claim 16 wherein the processor is configured to detect a fault at one of said client nodes.

18. The management node of claim 16 wherein the processor is configured to receive a fault notification message from one or said client nodes via the network interface.

19. A method implemented at a client node in a communication network of configuring a precision time protocol (PTP) entity at the client node, said method comprising:
sending PTP properties of the PTP entity to a management node;
receiving, from the management node, a PTP configuration for the PTP entity at the client node; and
executing, responsive to the receipt of the PTP configuration, a configuring procedure to configure the PTP entity according to the PTP configuration received from the management node.

20. The method of claim 19 wherein sending PTP properties of the PTP entity to a management node comprises sending a setup request including the PTP properties to the management node.

21. The method of claim 20 further comprising receiving, responsive to the setup request, a setup response including the PTP configuration sending PTP properties of the PTP entity to a management node.

22. The method of claim 19 further comprising:
detecting a fault condition; and
sending a fault notification message to the management node responsive to the fault condition.

23. The method of claim 19 wherein PTP configuration for the PTP entity at the client node is received responsive to detection of a fault at another client node.

24. A client node in communication network characterized by:
a network interface for communicating with a management node in the communication network; and
a processor connected to the network interface for configuring a precision time protocol (PTP) entity in the client node, said processor configured to:
send PTP properties of the PTP entity to a management node;
receive, from the management node, a PTP configuration for the PTP entity at the client node; and
execute, responsive to the receipt of the PTP configuration, a configuring procedure to configure the PTP entity according to the PTP configuration received from the management node.

25. The client node according to claim 24 wherein the processor is configured to send the PTP properties to the management node in a setup request.

26. The client node according to claim 25 wherein the processor is configured to receive the PTP properties of the PTP entity in a setup response transmitted by the management node responsive to the setup request.

27. The client node according to claim 24 wherein the processor is configured to detect a fault condition and send a fault notification message to the management node responsive to the fault condition.

28. The client node according to claim 24 wherein the processor is configured to receive the PTP properties of the PTP entity responsive to detection of a fault at another client node.
